(19) United States
(12) Patent Application Publication
(10) Pub. No.: US 2003/0093231 A1
(43) Pub. Date: May 15, 2003

(54) Method and apparatus for reducing engine chain vibration

(76) Inventor: O-Jun Kwon, Kunpo-City (KR)

Correspondence Address: Pennie & Edmonds, LLP, 3300 Hillview Avenue, Palo Alto, CA, 94304, US

(21) Appl. No.: 10/291,328

(22) Filed: Nov. 7, 2002

(30) Foreign Application Priority Data
Nov. 12, 2001 (KR) 2001-0070080

(51) Int. Cl. G06F 19/00

(52) U.S. Cl. 702/56

(57) ABSTRACT

Based on a sensor signal corresponding to vibrational displacement of a chain, an inverse phase vibration signal of the displacement of the chain is produced by a controller, and an actuator forcibly nullifies the vibration of the chain according to the inverse phase vibration signal.

### FIELD OF THE INVENTION

The present invention relates to an engine, and more particularly, to a method and apparatus for reducing engine chain vibration.

### BACKGROUND OF THE INVENTION+

A chain is frequently used in an engine in order to transmit torque between two different shafts. For example, intake and exhaust valves, the timing of which is based on crankshaft and camshaft rotation, are operated by torque transmitted from the crankshaft through a chain.

FIG. 3 shows a general scheme for such torque transmission from a crankshaft 12 to a camshaft 16. As shown in FIG. 3, a crankshaft sprocket 14 of the crankshaft 12, and a camshaft sprocket 18 of the camshaft 16, are connected by a chain 10. During torque transmission by the chain 10, vibration occurs at the chain 10 and the vibration is a source of noise, for example a whining noise. Such a noise is reduced, to some extent but not sufficiently, by a cover which covers the chain 10 and the sprockets 14 and 18.

Sometimes, a specially designed chain (usually called a silence chain) may be used to reduce generation of such a noise, but it greatly increases the manufacturing cost of an engine.

### SUMMARY OF THE INVENTION

An exemplary apparatus for reducing vibration of a chain of an engine according to an embodiment of the present invention includes a sensor for detecting vibration of the chain, an actuator for forcibly vibrating the chain, and a control unit for driving the actuator based on a signal from the sensor.

In a further embodiment, the control unit includes a low-pass filter for eliminating a high frequency component of a signal of the sensor, a processor for executing a predetermined program, and a converter for converting an analog signal of the low-pass filter to a digital signal and transmitting the converted digital signal to the processor and for converting a digital signal of the processor to an analog signal and transmitting the converted analog signal to the actuator. The predetermined program preferably comprises a set of instructions for detecting vibrational displacement of the chain using the sensor, calculating an inverse phase vibration of the displacement of the chain, and forcibly vibrating the chain based on the inverse phase vibration using the actuator.

In yet another embodiment, the calculating an inverse phase vibration comprises calculating vibration speed of the chain, and calculating a differential value of the vibration speed.

An exemplary method for reducing vibration of a chain of an engine according to an embodiment of the present invention includes detecting vibrational displacement of the chain using a sensor, calculating an inverse phase vibration of the displacement of the chain, and forcibly vibrating the chain based on the inverse phase vibration using an actuator.

In a further embodiment, the calculating an inverse phase vibration comprises calculating vibration speed of the chain, and calculating a differential value of the vibration speed.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic diagram of an apparatus for reducing vibration of a chain of an engine according to a preferred embodiment of the present invention;

FIG. 2 is a flowchart showing a method for reducing vibration of a chain of an engine according to a preferred embodiment of the present invention; and

FIG. 3 is a schematic drawing of a crankshaft and a camshaft connected to each other by a chain.

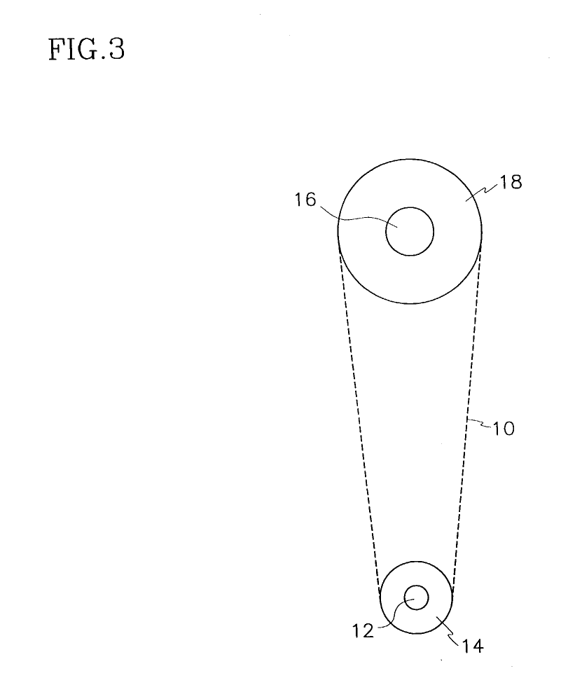

### DETAILED DESCRIPTION OF THE PREFERRED EMBODIMENTS

A preferred embodiment of the present invention will hereinafter be described in detail with reference to the accompanying drawings.

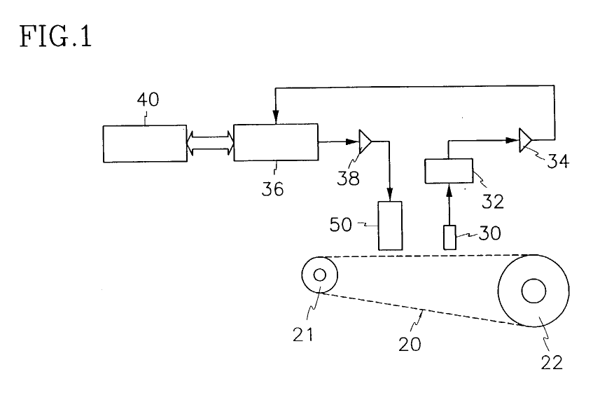

As shown in FIG. 1, an apparatus for reducing vibration of a chain of an engine according to a preferred embodiment of this invention includes a displacement sensor 30, disposed adjacent to the chain 20 for detecting vibrational displacement of the chain 20, and a low pass filter 32 for eliminating high frequency components from the signal of the displacement sensor 30. Chain 20 connects a crankshaft sprocket 21 fixed to a crankshaft to a camshaft sprocket 22 fixed to a camshaft.

In addition, the embodied apparatus for reducing vibration of a chain includes a control unit or electronic control unit (ECU) 40 for receiving a signal pertinent to the chain vibration and for generating a signal corresponding thereto. A Digital Signal Processing System Board (DSP board) 36 converts an analog signal of the low-pass filter 32 to a digital signal and transmits the converted digital signal to the ECU 40. DSP board 36 also converts a digital signal of the ECU 40 to an analog signal and outputs the converted analog signal. An actuator 50 forcibly vibrates the chain 20 according to the signal output from the DSP board 36.

A signal filtered at the low pass filter 32 is input to the DSP board 36 via an amplifier 34. Similarly, an analog signal converted at the DSP board 36 from a digital signal to an analog signal is transmitted to the actuator 50 via an amplifier 38.

According to a preferred embodiment, the ECU 40 performs specific steps for reducing chain vibration. These steps are preferably performed by one or more processors invoking a predetermined program. The predetermined program includes a set of instructions for performing the specific steps and are involved by the processor.

These specific steps are better understood when read in conjunction with the description of a preferred embodiment of a method for reducing chain vibration, which is provided below.

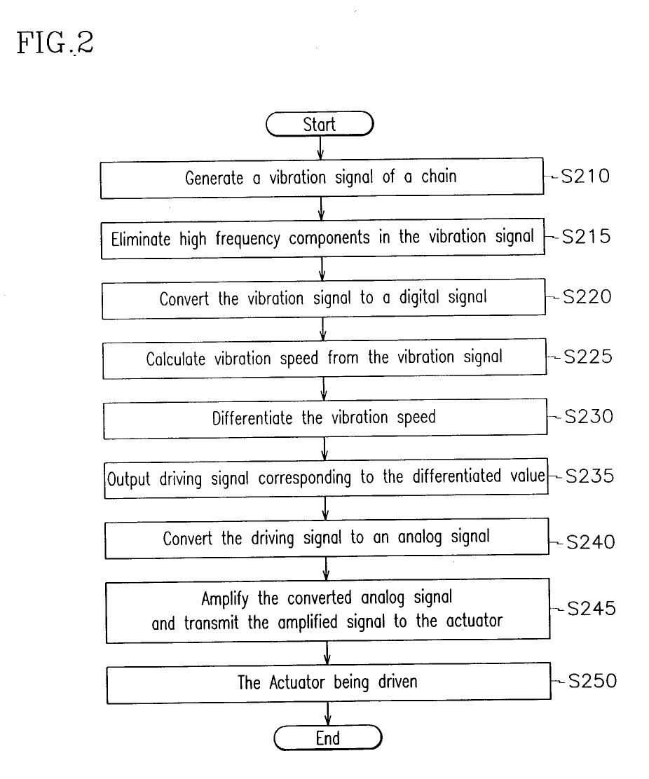

As shown in FIG. 2, during operation of the engine, the displacement sensor 30 continuously generates a signal corresponding to a distance between the sensor 30 and the chain 20 at step S210. In other words, the sensor 30 measures the vibrational displacement or original vibration of the chain.

The signal generated at the displacement sensor 30 is filtered by the low pass filter 32, and its high frequency components are eliminated at step S215. Accordingly, any noise produced at the sensor 30 is eliminated.

The filtered signal is amplified at the amplifier 34 and supplied to the DSP board 36. The DSP board 36 converts the received signal to a digital signal and supplies the converted signal to the ECU 40 at step S220.

The ECU 40 generates an inverse phase vibration signal based on the received signal.

In more detail, firstly the ECU 40 calculates a vibration speed of the chain 20 from the received signal at step S225. The calculation of the step S225 may be realized by differentiating the received signal related to displacement of the chain. Such calculated vibration speed has a phase difference of 90° with respect to the received signal.

Subsequently, the ECU 40 differentiates the vibration speed at step S230 such that the differentiated value has a phase difference of 180° with respect to the originally input signal. The phase difference of 180° means an inverse phase.

Subsequently, the ECU 40 outputs a driving signal, the driving signal having a phase that is inverse to the originally input vibration signal, to the DSP board 36 at step S235.

The driving signal is converted to an analog signal at the DSP board 36 at step S240, and the converted analog signal is amplified at the amplifier 38 and transmitted to the actuator 50 at step S245.

Finally, the actuator 50 is actuated by the transmitted signal at step S250, and it forces the chain 20 to move or vibrate against its original vibration. In other words, if the chain moves in a first direction, the actuator 50 causes the chain to move in a second direction opposite to the first direction.

The vibration of the chain 20 is thus reduced because the forced vibration has an inverse phase with respect to the originally generated vibration. Accordingly, any noise produced by the vibration of the chain 20 is also reduced.

As shown above, vibration of an engine chain is reduced by a preferred embodiment of this invention. Accordingly, noise produced by the vibration of the chain is reduced, thereby reducing the total amount of noise of the engine.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An apparatus for reducing engine chain vibration, comprising:
a sensor configured to detect an original vibration of a chain of an engine;
an actuator configured to forcibly vibrate the chain to counter the original vibration; and
a control unit configured to drive the actuator based on a signal from the sensor.

2. The apparatus of claim 1, further comprising:
a low-pass filter for eliminating a high frequency component of said signal;
a processor for executing a predetermined program; and
a converter for converting an analog signal of the low-pass filter to a converted digital signal and transmitting the converted digital signal to the processor, and for converting a digital signal of the processor to a converted analog signal and transmitting the converted analog signal to the actuator,
wherein the predetermined program comprises a set of instructions to execute:
detecting vibrational displacement of the chain using the sensor;
calculating an inverse phase vibration of the vibrational displacement of the chain; and
forcibly vibrating the chain based on the inverse phase vibration using the actuator.

3. The apparatus of claim 2, wherein the calculating an inverse phase vibration comprises:
calculating vibration speed of the chain; and
calculating a differential value of the vibration speed.

4. A method for reducing vibration of a chain of an engine comprising:
detecting vibrational displacement of a chain of an engine; and
forcibly vibrating the chain to oppose the vibrational displacement.

5. The method of claim 4, further comprising, before said forcibly vibrating, calculating an inverse phase vibration of the displacement of the chain.

6. The method of claim 5, wherein said forcibly vibrating is based on the inverse phase vibration.

7. The method of claim 5, wherein the calculating an inverse phase vibration comprises:
calculating vibration speed of the chain; and
calculating a differential value of the vibration speed.

8. The method of claim 4, wherein said detecting is performed by a displacement sensor disposed adjacent said chain.

9. The method of claim 4, wherein said forcibly vibrating is performed by an actuator disposed adjacent said chain.
